(19) United States
(12) Patent Application Publication
(10) Pub. No.: US 2026/0139717 A1
(43) Pub. Date: May 21, 2026

(54) ELECTRIC BRAKING DEVICE

(71) Applicant: ADVICS CO., LTD., Kariya-shi, Aichi-ken (JP)

(72) Inventor: Yasutoshi KITAHARA, Kariya-shi, Aichi-ken (JP)

(73) Assignee: ADVICS CO., LTD., Kariya-shi, Aichi-ken (JP)

(21) Appl. No.: 19/118,566

(22) PCT Filed: Oct. 3, 2023
(86) PCT No.: PCT/JP2023/036054

§ 371 Date: Apr. 4, 2025

(30) Foreign Application Priority Data
Oct. 4, 2022 (JP) 2022-160591

(51) Int. Cl. F16D 65/18; F16D 66/00

(52) U.S. Cl. CPC F16D 65/18; F16D 66/00; F16D 2066/005

(57) ABSTRACT

An electric braking device includes a lever member to which a reaction force of a pressing load of a friction member is input via a rotation part, the lever member extending to an outer side of a projection region that is a region obtained by projecting a linear motion conversion mechanism in a rotational axis direction of the rotation part, and a load sensor configured to detect the reaction force input to the lever member by abutting on a portion of the lever member extending to the outer side of the projection region.

### TECHNICAL FIELD

The present disclosure relates to an electric braking device.

### BACKGROUND ART

Conventionally, as in Patent Literature 1, there is known a disk brake device in which a brake pad is pressed against a brake disk that rotates together with a wheel by driving of an electric motor to apply a braking force to the wheel. The disk brake device includes a detection device configured to detect a reaction force of a pressing load generated on a brake pad when the brake pad is pressed against the brake disk.

### CITATIONS LIST

### Patent Literature

Patent Literature 1: WO2020/229989

### SUMMARY

### Technical Problems

The detection device includes a sensor configured to detect a load. The sensor included in the detection device is a ring-shaped sensor, and a shaft member through which a reaction force of a pressing load generated on the brake pad is transmitted is inserted into a center through-hole. The ring-shaped sensor detects a reaction force of a pressing load generated on the brake pad via the shaft member.

However, in such a ring-shaped sensor, a plurality of detection units for detecting a reaction force along the circumferential direction of the sensor need to be provided in order to detect a load transmitted from the shaft member. Therefore, there is a problem that the cost of the sensor increases and the cost of the disk brake device increases.

An object of one aspect of the present disclosure is to provide an inexpensive electric braking device.

### Solutions to Problems

In order to solve the above problem, an electric braking device according to one aspect of the present disclosure is an electric braking device in which a rotary motion of an electric motor is transmitted to a rotation part of a linear motion conversion mechanism, the rotary motion of the rotation part is converted into a linear motion of a linear motion part of the linear motion conversion mechanism, and a friction member is pressed against a rotating body rotating together with a wheel according to the linear motion of the linear motion part to generate a braking force on the wheel, the electric braking device including: an input member to which a reaction force of a pressing load of the friction member is input via the rotation part, the input member extending to an outer side of a projection region that is a region obtained by projecting the linear motion conversion mechanism in a rotational axis direction of the rotation part, and a load sensor configured to detect the reaction force input to the input member by abutting on a portion of the input member extending to the outer side of the projection region.

### Advantageous Effects

According to one aspect of the present disclosure, an inexpensive electric braking device can be provided.

### BRIEF DESCRIPTION OF DRAWINGS

FIG. 1 is a schematic cross-sectional view illustrating an outline of an electric braking device according to a first embodiment.

FIG. 2 is a schematic cross-sectional view in which a broken line portion illustrated in FIG. 1 is enlarged.

FIG. 3 is a schematic view of a lever member illustrated in FIG. 1 as viewed from an X2 direction.

FIG. 4 is a diagram for explaining deflection of ae caliper generated when a reaction force of a pressing load of a friction member acts.

FIG. 5 is a schematic cross-sectional view illustrating an outline of a main part of an electric braking device according to a second embodiment.

### DESCRIPTION OF EMBODIMENTS

### First Embodiment

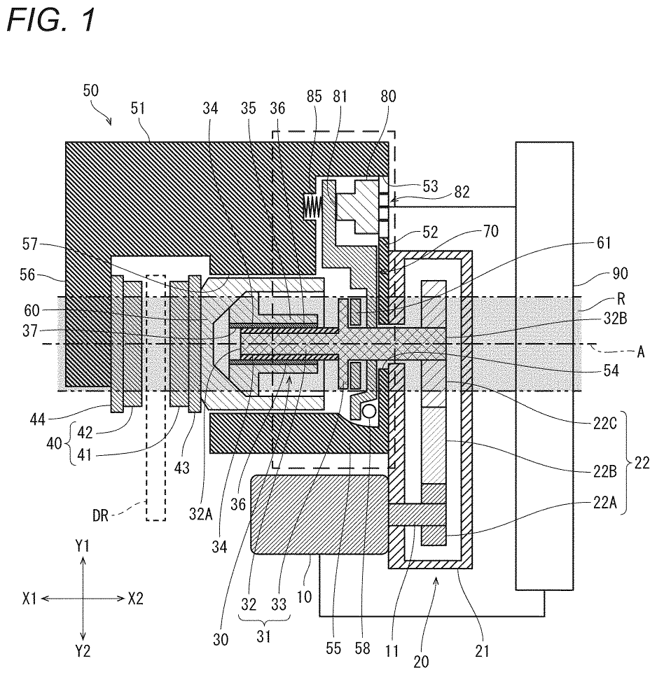

Hereinafter, a first embodiment of the present disclosure will be described in detail with reference to FIGS. 1 through 4. Note that in the following description, coordinate axes of an X (X1-X2) direction, a Y (Y1-Y2) direction, and a Z (Z1-Z2) direction as illustrated in FIG. 1 and the like are defined and described.

### Outline of Electric Braking Device

An outline of the electric braking device 1 will be described with reference to FIG. 1. FIG. 1 is a schematic cross-sectional view illustrating an outline of the electric braking device 1. Examples of a device to which the electric braking device 1 is applied include an electromechanical brake called an electro mechanical brake (EMB). As illustrated in FIG. 1, the electric braking device 1 includes an electric motor 10, a linear motion conversion mechanism 30, a friction member 40, a lever member 70, and a load sensor 80. Furthermore, the electric braking device 1 may further include a transmission mechanism 20, a caliper 50, a piston 60, a thrust bearing 61, an urging part 85, and an electronic control unit (ECU) 90.

The electric motor 10 is a power source of the electric braking device 1. The electric motor 10 may be electrically connected to the ECU 90 and driven under the control of the ECU 90. The electric motor 10 is disposed outside the caliper 50 so as to be adjacent to the caliper 50. The electric motor 10 has a rotating shaft 11 provided with a spur gear that meshes with the gear 22A of the transmission mechanism 20. When the electric motor 10 is driven, the rotating shaft 11 rotates, and the rotary motion is transmitted to the transmission mechanism 20 connected to the rotating shaft 11.

The transmission mechanism 20 is a mechanism configured to transmit rotary motion of the electric motor 10. The transmission mechanism 20 is disposed outside the caliper 50. Inside a housing 21 of the transmission mechanism 20 are provided one or more gears 22 to which the rotary motion from the electric motor 10 is transmitted. The transmission mechanism 20 transmits the rotary motion of the electric motor 10 to the rotation part 31 of the linear motion conversion mechanism 30 via one or more gears 22. In the example illustrated in FIG. 1, the transmission mechanism 20 includes three gears 22A through 22C. The transmission mechanism 20 may be a speed reduction mechanism configured to speed-reduce the rotary motion transmitted from the electric motor 10. However, the transmission mechanism 20 is not an essential configuration of the electric braking device 1.

The linear motion conversion mechanism 30 is a mechanism configured to convert the rotary motion of the electric motor 10 into linear motion. The linear motion conversion mechanism 30 includes a rotation part 31 to which the rotary motion of the electric motor 10 is transmitted, and a linear motion part 35 configured to convert the rotary motion of the rotation part 31 into a linear motion.

The rotation part 31 of the linear motion conversion mechanism 30 includes a rotating shaft portion 32 and a flange portion 33. The rotating shaft portion 32 has the X direction as a rotation center A. In the present embodiment, the X direction is a rotational axis direction of the rotation part 31. The flange portion 33 is provided between a first end portion 32A on a friction member 40 side of the rotating shaft portion 32 and a second end portion 32B on the transmission mechanism 20 side of the rotating shaft portion 32. The flange portion 33 extends from the rotating shaft portion 32 toward the outward direction of the rotating shaft portion 32 in the radial direction of the rotating shaft portion 32. A spur gear is provided at the second end portion 32B of the rotating shaft portion 32, and meshes with an internal tooth of the gear 22C of the transmission mechanism 20. In the rotating shaft portion 32, a male screw structure 34 is formed in a region from the flange portion 33 to the first end portion 32A of the rotating shaft portion 32.

The linear motion part 35 of the linear motion conversion mechanism 30 is a tubular member having an insertion hole 37 into which the rotation part 31 is inserted. A female screw structure 36 to which the male screw structure 34 of the rotation part 31 is screw-fitted is formed on an inner peripheral surface of the insertion hole 37. The rotary motion of the rotation part 31 is converted into the linear motion in the linear motion part 35 by screw-fitting the male screw structure 34 and the female screw structure 36. More specifically, when the rotary motion of the electric motor 10 in the first rotating direction is transmitted to the rotation part 31, the linear motion part 35 linearly moves in the X1 direction, and when the rotary motion of the electric motor 10 in the second rotating direction opposite to the first rotating direction is transmitted to the rotation part 31, the linear motion part linearly moves in the X2 direction. The piston 60 provided at the distal end of the linear motion part 35 on the friction member 40 side interlocks with the linear motion of the linear motion part 35.

Note that a male screw structure may be provided in the linear motion part 35, and a female screw structure may be provided in the rotation part 31. The screw structure included in the linear motion conversion mechanism 30 is an example of a configuration that converts rotary motion into linear motion. In addition, the linear motion part 35 may include a rotation lock mechanism that prevents the linear motion part 35 from performing a rotary motion in the cylinder portion 57 by the rotary motion of the rotation part 31.

The friction member 40 generates a braking force on the wheel by pressing the disk rotor DR that rotates together with the wheel according to the linear motion of the linear motion part 35. The disk rotor DR is an example of a rotating body. The friction member 40 includes a first friction member 41 and a second friction member 42 disposed to face each other in the axial direction (X direction) of the disk rotor DR with the disk rotor DR interposed therebetween. The first friction member 41 is disposed on the linear motion conversion mechanism 30 side. The second friction member 42 is disposed on the opposite side of the first friction member 41 with the disk rotor DR sandwiched therebetween. The first friction member 41 is attached to the piston 60 by way of an attachment plate 43. The second friction member 42 is attached to the caliper 50 by way of an attachment plate 44.

The first friction member 41 is interlocked with the linear motion of the piston 60. That is, the first friction member 41 is a member that presses the disk rotor DR in conjunction with the linear motion of the linear motion part 35 to generate a braking force on the wheel. When the first friction member 41 linearly moves in the X1 direction, which is the direction toward the disk rotor DR, the disk rotor DR is sandwiched between the first friction member 41 and the second friction member 42, and the disk rotor DR is pressed. When the disk rotor DR is pressed by the first friction member 41 and the second friction member 42, frictional force is generated between the first friction member 41 and the disk rotor DR and between the second friction member 42 and the disk rotor DR. This frictional force acts on the wheel as a force in a direction opposite to the rotating direction of the disk rotor DR. As a result, the friction member 40 applies a braking force on the wheel. When the pressing load by the friction member 40 is strong, the frictional force with respect to the disk rotor DR becomes strong, and the braking force with respect to the wheel becomes strong. When the pressing load by the friction member 40 is weak, the frictional force with respect to the disk rotor DR becomes weak, and the braking force with respect to the wheel becomes weak.

On the other hand, when the first friction member 41 moves in the X2 direction, which is the direction away from the disk rotor DR, the pressing of the disk rotor DR by the first friction member 41 and the second friction member 42 is released. Since no frictional force is generated with respect to the disk rotor DR, the braking force on the wheel by the friction member 40 disappears.

The caliper 50 is a member that accommodates or supports a part of the members constituting the electric braking device 1. The caliper 50 has a shape that crosses over the outer periphery of the disk rotor DR with the first friction member 41 and the second friction member 42 interposed therebetween.

The caliper 50 includes a base wall 51, a first extending wall 52, a second extending wall 55, a third extending wall 56, and a cylinder portion 57. The base wall 51 is provided along the X direction. The first extending wall 52 is a wall extending from the base wall 51 and extending along the Y direction. More specifically, it is formed so as to extend in the Y2 direction from an end portion on the X2 direction side of the base wall 51. Note that the first extending wall 52 may extend from a portion other than the end portion on the X2 direction side of the base wall 51. An opening 53 and an opening 54 are formed in the first extending wall 52. The opening 53 is an opening formed to connect the load sensor 80 located inside the caliper 50 and the ECU 90 located outside the caliper 50. The opening 54 is an opening for connecting the linear motion conversion mechanism 30 inside the caliper 50 and the transmission mechanism 20 outside the caliper 50.

The second extending wall 55 of the caliper 50 is a wall extending from the first extending wall 52 and extending along the X direction. More specifically, the second extending wall 55 is a wall extending in the X1 direction from the end portion on the Y2 direction side of the first extending wall 52. Note that the second extending wall 55 may extend from a portion other than the end portion on the Y2 direction side of the first extending wall 52. The third extending wall 56 of the caliper 50 is a wall extending from the base wall 51 on the side opposite to the side on which the first extending wall 52 extends and extending along the Y direction. More specifically, the third extending wall 56 is formed to extend in the Y2 direction from an end portion on the X1 direction side of the base wall 51. Note that the third extending wall 56 may extend from a portion other than the end portion on the X1 direction side of the base wall 51. The second friction member 42 is attached to the X2 direction side of the third extending wall 56 by way of the attachment plate 44.

The cylinder portion 57 is provided in the caliper 50. The cylinder portion 57 is a portion constituting a circular columnar space having the X direction as an axial direction. The base wall 51, the first extending wall 52, and the second extending wall 55 of the caliper 50 constitute a part of the cylinder portion 57. The linear motion conversion mechanism 30 is accommodated in the space of the cylinder portion 57. Furthermore, the piston 60 is accommodated in the space of the cylinder portion 57. The piston 60 linearly moves in the—X direction in the space of the cylinder portion 57. Note that the cylinder portion 57 may be provided in the caliper 50 as a separate member having a circular columnar space.

The ECU 90 is a control unit configured to control the electric braking device 1. The ECU 90 is an example of a control unit. The ECU 90 is an electronic control unit configured by a processor such as a central processing unit (CPU) and a computer including a memory such as a RAM or a ROM. The ECU 90 includes a drive circuit for driving the electric motor 10 and an input/output interface for acquiring data on the load detected by the load sensor 80. The ECU 90 is disposed outside the caliper 50. The ECU 90 may be disposed on the side opposite to the lever member 70 with the load sensor 80 sandwiched therebetween in the X direction. The ECU 90 is electrically connected to the electric motor 10 and the load sensor 80. The ECU 90 may control driving of the electric motor 10 based on data from the load sensor 80.

### Configuration of Load Sensor and Lever Member

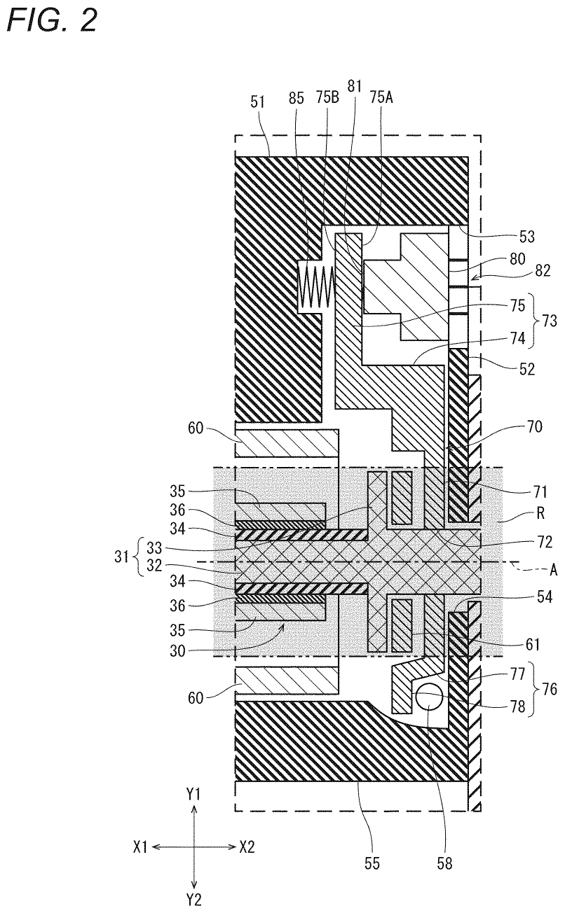

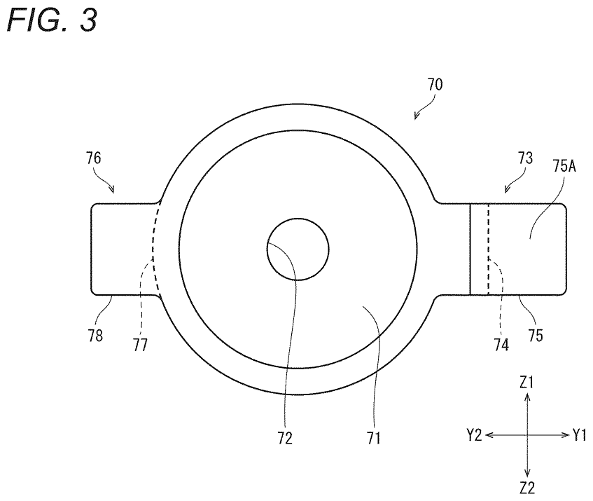

Configurations of the lever member 70 and the load sensor 80 will be described with reference to FIGS. 2 and 3. FIG. 2 is a schematic cross-sectional view in which a broken line portion illustrated in FIG. 1 is enlarged. FIG. 3 is a schematic view of a lever member illustrated in FIG. 1 as viewed from an X2 direction.

As illustrated in FIG. 2, the lever member 70 is an input member to which a reaction force (load) of a pressing load of the first friction member 41 is input via the rotation part 31 of the linear motion conversion mechanism 30. The lever member 70 extends to the outer side of a projection region R which is a region projected in the X direction of the rotation part 31. Note that in the following description, when simply referred to as a reaction force, it refers to a reaction force of a pressing load of the first friction member 41. The portion of the lever member 70 abutted on the load sensor 80 may have rigidity equal to the portion of the caliper 50 that crosses the outer periphery of the disk rotor DR. The lever member 70 is disposed between the flange portion 33 of the rotation part 31 and the second end portion 32B of the rotating shaft portion 32 of the rotation part 31 in the X direction. The lever member 70 includes a base portion 71, a first protrusion 73, and a second protrusion 76.

As illustrated in FIG. 3, the base portion 71 of the lever member 70 is a disk-like member, and a through-hole 72 is formed at the center part. Note that the base portion 71 is not limited to a disk-like shape. The base portion 71 is a portion to which a reaction force is input with respect to the lever member 70. The base portion 71 has a portion located on the inner side of the projection region R. The rotating shaft portion 32 of the rotation part 31 of the linear motion conversion mechanism 30 is inserted into the through-hole 72. The through-hole 72 is larger than the outer diameter of the rotating shaft portion 32 of the rotation part 31 and has a size of an extent of having a space with the rotating shaft portion 32. As illustrated in FIG. 2, the base portion 71 abuts on the thrust bearing 61 disposed between the lever member 70 and the flange portion 33 in the X direction.

Note that the base portion 71 may be configured to abut on an unbalanced load reducing mechanism configured to reduce the reaction force input from the flange portion 33 of the rotation part 31 to the base portion 71 from deviating. An example of the unbalanced load reducing mechanism includes a spherical receiving member in which a surface of the rotation part 31 on the flange portion 33 side is a surface in a direction orthogonal to the X direction, and a surface abutting on the base portion 71 is a curved surface. Furthermore, the base portion 71 may be configured to abut on the flange portion 33 of the rotation part 31.

The first protrusion (protrusion) 73 of the lever member 70 is a portion that abuts on the load sensor 80. The first protrusion 73 is a portion that protrudes out from the base portion 71 on the outer side of the projection region R. The first protrusion 73 may be configured to partially protrude out from the base portion 71 to the outer side of the projection region R. Note that the lever member 70 may have a configuration in which the first protrusion 73 is not provided, and base portion 71 and the load sensor 80 abut on each other.

As described above, when the first protrusion 73 of the lever member 70 and the load sensor 80 abut on each other, the size of the lever member 70 is reduced as compared with a structure of extending to the outer side of the projection region R from all directions around the base portion 71 in the X direction, and other components of the electric braking device 1 can be disposed in a portion where the first protrusion 73 does not exist. Thus, the electric braking device 1 can be downsized.

The first protrusion 73 may be configured to be located closer to the friction member 40 than the base portion 71 in the X direction. According to the above configuration, the load sensor 80 can be brought close to the friction member 40 side in the X direction. As a result, the electric braking device 1 can be downsized in the X direction.

The first protrusion 73 of the lever member 70 has a first wall 74 and a second wall 75. The first wall 74 is a wall extending along a direction facing the first friction member 41 in the X direction. More specifically, as illustrated in FIG. 2, the first wall 74 extends in the X1 direction from the peripheral edge portion of the base portion 71. Note that the first wall 74 may extend from a portion other than the peripheral edge portion of the base portion 71. In other words, the first protrusion 73 may be configured to protrude out from a portion other than the peripheral edge portion of the base portion 71. In addition, a wall extending in the Y direction orthogonal to the X direction may be formed between the base portion 71 and the first wall 74.

As illustrated in FIG. 2, the second wall 75 of the first protrusion 73 is a wall extending along the Y direction on the distal end side of the first protrusion 73 with respect to the first wall 74. More specifically, the second wall 75 extends in the Y1 direction from the end portion on the X1 direction side of the first wall 74. The load sensor 80 abuts on the second wall 75. More specifically, the load sensor 80 abuts on the surface 75A of the second wall on the X2 direction side. Note that a wall extending in the X direction and a wall extending in the Y direction may be formed between the second wall 75 and the first wall 74. The first protrusion 73 may not have the second wall 75, and the first wall 74 may be configured to abut on the load sensor 80.

The first protrusion 73 of the lever member 70 is urged in the X2 direction by the urging part 85 supported by the caliper 50. More specifically, the first protrusion 73 is urged by the urging part 85 in a direction of abutting on the load sensor 80. The urging part 85 is provided on the X1 direction side than the first protrusion 73 and abuts on a surface 75B on the X1 direction side of the first protrusion 73. As a result, the first protrusion 73 can be brought to abut on the load sensor 80 in a stable state.

The second protrusion 76 of the lever member 70 is a portion supported by the caliper 50. The second protrusion 76 is a portion that protrudes out from the base portion 71 on the outer side of the projection region R. As illustrated in FIGS. 2 and 3, the second protrusion 76 is located on the side opposite to the first protrusion 73 with the rotation part 31 sandwiched in between in the Y direction. The second protrusion 76 and the first protrusion 73 are provided so as to be located on the same straight line passing through the rotation center A of the rotation part 31 in the Y direction. That is, the portion of the lever member 70 supported by the caliper 50 and the portion of the lever member 70 that abuts on the load sensor 80 are provided so as to be located on the same straight line passing through the rotation center A in the direction orthogonal to the X direction.

The second protrusion 76 of the lever member 70 has a third wall 77 and a fourth wall 78. As illustrated in FIG. 3, the third wall 77 extends in the X1 direction from the peripheral edge portion of the base portion 71. Note that the third wall 77 may extend from a portion other than the peripheral edge portion of the base portion 71. In other words, the second protrusion 76 may be configured to protrude out from a portion other than the peripheral edge portion of the base portion 71. In addition, a wall extending in the Y direction may be formed between the base portion 71 and the third wall 77. As illustrated in FIG. 2, the fourth wall 78 extends from the end portion on the X1 direction side of the third wall 77 toward the Y2 direction side. The fourth wall 78 is supported by a support part 58 provided on the caliper 50. Note that a wall extending in the X direction and a wall extending toward the Y direction may be formed between the fourth wall 78 and the third wall 77. Furthermore, the lever member 70 may have a configuration in which the second protrusion 76 is not provided, and base portion 71 is supported by the caliper 50.

The load sensor 80 is a sensor configured to detect a reaction force input to the lever member 70 by coming into abutment with a portion of the lever member 70 extending to the outer side of the projection region R. As illustrated in FIG. 2, the load sensor 80 includes an abutment portion 81 which is a portion that abuts on the lever member 70. The load sensor 80 detects the reaction force input to the lever member 70. The load sensor 80 detects the reaction force input to the lever member 70 by abutting on the first protrusion 73. The load sensor 80 is located on the outer side of the projection region R. The load sensor 80 is disposed so as to be located on a side opposite to the electric motor 10 with the rotation part 31 sandwiched in between in the Y direction.

Furthermore, the load sensor 80 is disposed such that a terminal 82 for electrical connection with the ECU 90 is located on the X2 direction side. The terminal 82 is provided on the ECU 90 side in the X direction. The ECU 90 is disposed on the side opposite to the lever member 70 with the load sensor 80 sandwiched in between in the X direction, and the terminal 82 is provided on the ECU 90 side in the X direction, so that the terminal 82 and the ECU 90 are in a positional relationship facing each other, and the electrical connection between the load sensor 80 and the ECU 90 can be simplified.

The load sensor 80 is supported by the caliper 50 in a space of the cylinder portion 57 of the caliper 50. Note that the load sensor 80 may be configured to be supported outside the caliper 50. Furthermore, the plurality of load sensors 80 may abut on the lever member 70. In addition, the load sensor 80 may have rigidity equal to that of a portion of the caliper 50 that straddles the outer periphery of the disk rotor DR.

According to the electric braking device 1 described above, since the electric braking device 1 includes the lever member 70 that abuts on the load sensor 80, the load sensor 80 can be disposed outside the projection region R. Furthermore, the load sensor 80 may detect a reaction force at a portion abutting on the lever member 70. Therefore, it is not necessary to adopt the ring-shaped load sensor 80, and the inexpensive load sensor 80 having a small detection unit can be adopted for the electric braking device 1. Thus, the inexpensive electric braking device 1 can be provided. In addition, the configuration of abutting on the lever member 70 allows the shape of the load sensor 80 to be freely selected. As a result, the degree of freedom of the load sensor 80 to be used can be increased.

### Flow until Reaction Force is Detected

A flow until the load sensor 80 of the electric braking device 1 detects the reaction force will be described with reference to FIG. 1. When the electric motor 10 is driven, the rotary motion of the electric motor 10 is transmitted to the linear motion conversion mechanism 30 via the transmission mechanism 20. When the rotary motion of the electric motor 10 in the first rotating direction is transmitted to the linear motion conversion mechanism 30, the first friction member 41 linearly moves in the X1 direction in conjunction with the piston 60. When the first friction member 41 linearly moves in the X1 direction, the disk rotor DR of the wheel is pressed so as to be sandwiched with the second friction member 42. When the disk rotor DR of the wheel is pressed, a reaction force of a pressing load is generated in the first friction member 41.

The reaction force is transmitted to the linear motion conversion mechanism 30 via the attachment plate 43 and the piston 60. In the linear motion conversion mechanism 30, the reaction force transmitted to the linear motion part 35 is transmitted to the rotation part 31. The reaction force transmitted to the rotation part 31 is input to the lever member 70 via the rotation part 31. More specifically, the reaction force is input from the flange portion 33 of the rotation part 31 to the base portion 71 of the lever member 70 via the thrust bearing 61.

When the reaction force is input to the base portion 71 of the lever member 70, a force applied in a direction inclined to the X2 direction side with the fourth wall 78 of the second protrusion 76 as a fulcrum acts on the lever member 70. When a force inclined toward the X2 direction side with respect to the lever member 70 is generated, a reaction force is input to the load sensor 80 via the lever member 70. More specifically, the reaction force is input to the load sensor 80 via the second wall 75 of the first protrusion 73 of the lever member 70. That is, the lever member 70 is configured such that a portion supported by the caliper 50 serves as a fulcrum, a portion to which a reaction force is input serves as a point of force, and a portion abutting on the load sensor 80 serves as a point of action.

According to the above configuration, the magnitude of the reaction force detected by the load sensor 80 can be changed by applying the principle of leverage. Therefore, the type of the load sensor 80 can be appropriately selected according to the magnitude of the reaction force detected by the load sensor 80. As a result, a degree of freedom is generated in the type of the load sensor 80 to be adopted.

Furthermore, in the Y direction, the portion to which the reaction force of the lever member 70 is input may be located between the portion supported by the caliper 50 and the portion abutting on the load sensor 80. More specifically, in the Y direction, the portion to which the reaction force is input with respect to the base portion 71 of the lever member 70 may be located between the fourth wall 78 of the second protrusion 76 supported by the cylinder portion 57 of the caliper 50 and the second wall 75 of a first protruding wall abutting on the load sensor 80. That is, in the lever member 70, the distance between the portion functioning as the fulcrum and the portion functioning as the point of action is longer than the distance between the portion functioning as the fulcrum and the portion acting as the point of force. Therefore, the magnitude of the reaction force detected by the load sensor 80 can be made smaller than the magnitude of the reaction force input to the lever member 70. Therefore, the load sensor 80 in which the magnitude of the load that can be detected is small can be adopted in the electric braking device 1. Thus, the inexpensive electric braking device 1 can be provided.

### Deflection of Caliper When Reaction Force is Received

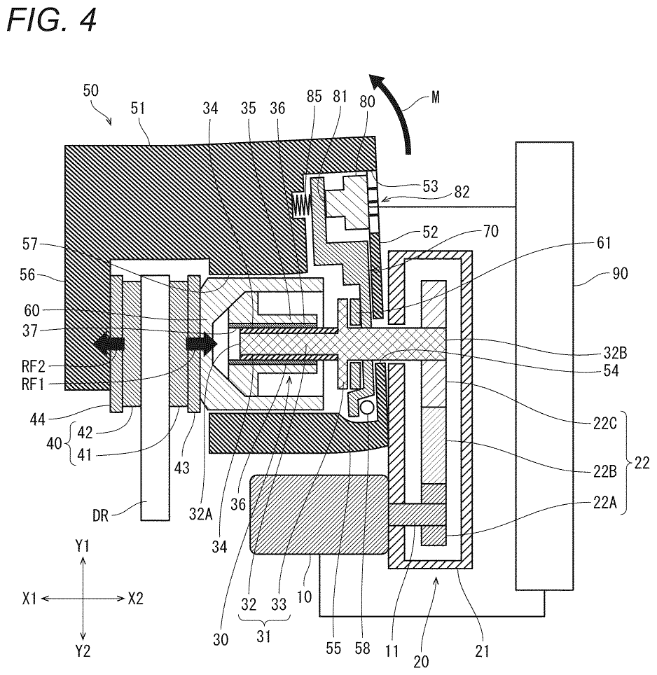

The relationship between the deflection of the caliper 50 at the time of receiving the reaction force and the lever member 70 will be described with reference to FIG. 4. FIG. 4 is a diagram for explaining the deflection of the caliper 50 caused when the reaction force acts. Note that in FIG. 4, the description on the projection region R and the rotation center A of rotation part 31 will be omitted in consideration of easy viewing of the drawing.

As illustrated in FIG. 4, when a reaction force RF1 of the pressing load of the first friction member 41 is generated, the reaction force RF1 is transmitted to the base wall 51, the first extending wall 52, and the second extending wall 55 of the caliper 50 via the piston 60 and the linear motion conversion mechanism 30. When a reaction force RF2 of the pressing load of the second friction member 42 is generated, the reaction force RF2 is transmitted to the third extending wall 56 of the caliper 50 via the attachment plate 44.

When the reaction force RF1 is transmitted to the caliper 50, a rotational moment M acts on the caliper 50. More specifically, the rotational moment M about an end portion of the base wall 51 on the X1 direction side acts on the base wall 51. When the rotational moment M acts on the caliper 50, the caliper 50 deflects to the Y1 direction side.

When the caliper 50 is deflected to the Y1 direction side, at least one of the lever member 70 and the load sensor 80 is deformed due to the deflection of the caliper 50. Here, since at least one of the portion of the lever member 70 abutting on the load sensor 80 or the load sensor 80 and the portion of the caliper 50 crossing over the outer periphery of the disk rotor DR have equal rigidity, the deformation amount of the deflection of the portion of the caliper 50 having a shape of crossing over the outer periphery of the disk rotor DR (the portion of the beam of the caliper) and the deformation amount of the lever member 70 abutting on the load sensor 80 or the deformation amount of the load sensor 80 caused by the deflection of the caliper 50 can be made substantially equal. Therefore, the abutment state between a male screw structure 34 and a female screw structure 36 or the abutment state between the thrust bearing 61 and the lever member 70 does not change depending on whether or not the braking force is applied to the wheel. As a result, an unbalanced load on the screw structures 34 and 36 or the thrust bearing 61 is suppressed, and the durability of the electric braking device 1 is improved.

### Second Embodiment

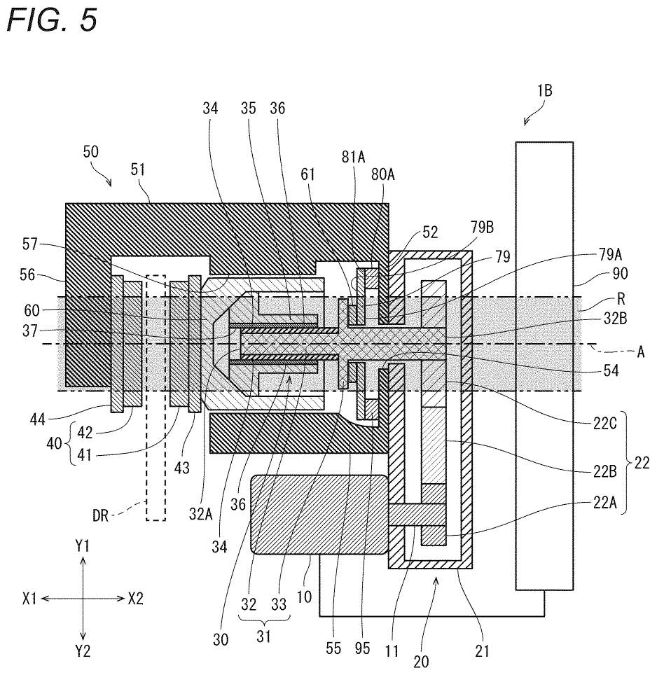

A second embodiment of the present disclosure will be described below with reference to FIG. 5. FIG. 5 is a schematic diagram illustrating an outline of a main part of an electric braking device 1A according to a second embodiment of the present disclosure. For the sake of convenience of description, members having the same functions as the members described in the first embodiment are denoted by the same reference numerals, and the description thereof will not be repeated. The electric braking device 1A according to the second embodiment is different from the electric braking device 1 according to the first embodiment in that the input member 79 is supported in the caliper 50 by a load sensor 80A and the supporting member 95. That is, the principle of leverage is not applied to the input member 79 of the electric braking device 1A.

The electric braking device 1A includes a supporting member 95 that supports the input member 79. The supporting member 95 is supported by the caliper 50. More specifically, the supporting member 95 is supported by the first extending wall 52 of the caliper 50. The supporting member 95 is disposed at a position different from the load sensor 80 in a direction orthogonal to the X direction. More specifically, the supporting member 95 is disposed on the side opposite to the load sensor 80A with the rotation part 31 sandwiched in between in the Y direction. The supporting member 95 is a member having rigidity equivalent to that of the load sensor 80A.

The electric braking device 1A includes a flat plate shaped input member 79 to which a reaction force is input via the rotation part 31. The input member 79 is supported in the caliper 50 by the supporting member 95 and the load sensor 80A. The load sensor 80A includes an abutment portion 81A that is a portion that abuts on the input member 79. The abutment portion 81A is located on the outer side of the projection region R. The reaction force input to the input member 79 is dispersed to the supporting member 95 and the load sensor 80A. Therefore, the load sensor 80A in which the magnitude of the load that can be detected is small can be adopted in the electric braking device 1A. Note that the input member 79 is not limited to a flat plate shape.

According to the above configuration, with the configuration of having the rigidity of the supporting member 95 equal to the rigidity of the load sensor 80A, even if the reaction force is input to the input member 79, the change in angle at which the input member 79 and the load sensor 80A come into contact can be made difficult to occur. As a result, the possibility of the detection accuracy of the reaction force by the load sensor 80A reducing can be alleviated.

### Other Embodiments

In the above-described embodiments, the configuration in which the first friction member 41 of the friction member 40 is interlocked with the linear motion part 35 of the linear motion conversion mechanism 30 has been described, but the present disclosure is not limited thereto. The second friction member 42 of the friction member 40 may be configured to interlock with the linear motion part of the linear motion conversion mechanism. That is, the first friction member 41 and the second friction member 42 may linearly move together.

The present disclosure is not limited to the above-described embodiments, and various modifications can be made within the scope indicated in the Claims, and embodiments obtained by appropriately combining technical means disclosed in different embodiments are also included in the technical scope of the present disclosure.

1. An electric braking device in which a rotary motion of an electric motor is transmitted to a rotation part of a linear motion conversion mechanism, the rotary motion of the rotation part is converted into a linear motion of a linear motion part of the linear motion conversion mechanism, and a friction member is pressed against a rotating body rotating together with a wheel according to the linear motion of the linear motion part to generate a braking force on the wheel, the electric braking device comprising:
an input member to which a reaction force of a pressing load of the friction member is input via the rotation part, the input member extending to an outer side of a projection region that is a region obtained by projecting the linear motion conversion mechanism in a rotational axis direction of the rotation part; and
a load sensor configured to detect the reaction force input to the input member by abutting on a portion of the input member extending to the outer side of the projection region.

2. The electric braking device according to claim 1, wherein
the input member includes:
a base portion to which the reaction force is input, the base portion being a portion in the projection region, and
a protrusion that partially protrudes out from the base portion to the outer side of the projection region; and
the load sensor detects the reaction force input to the input member by abutting on the protrusion.

3. The electric braking device according to claim 2, wherein the protrusion is configured to be located closer to the friction member than the base portion in the rotational axis direction.

4. The electric braking device according to claim 1, further comprising:
a caliper configured to accommodate the linear motion conversion mechanism, wherein
the input member is supported by the caliper, a portion supported by the caliper functioning as a fulcrum, a portion to which the reaction force is input functioning as a point of force, and a portion abutting on the load sensor functioning as a point of action.

5. The electric braking device according to claim 4, wherein the input member is configured such that a portion of the input member to which the reaction force is input is located between the portion supported by the caliper and the portion abutting on the load sensor in a direction orthogonal to the rotational axis direction.

6. The electric braking device according to claim 1, further comprising:
a caliper configured to accommodate the linear motion conversion mechanism; and
a supporting member supported by the caliper and disposed at a position different from the load sensor in a direction orthogonal to the rotational axis direction; wherein
the input member is supported in the caliper by the supporting member and the load sensor supported by the caliper, and
the supporting member has rigidity equal to rigidity of the load sensor.

7. The electric braking device according to claim 1, further comprising:
a control unit disposed on a side opposite to the input member with the load sensor sandwiched in between in the rotational axis direction and configured to control driving of the electric motor, wherein
the load sensor includes a terminal provided on the control unit side in the rotational axis direction, the terminal electrically connecting the load sensor and the control unit.

8. The electric braking device according to claim 1, wherein
the friction member includes a first friction member and a second friction member disposed to face each other with a rotating body in between in an axial direction of the rotating body,
the electric braking device further includes a caliper having a shape that crosses an outer periphery of the rotating body with the first friction member and the second friction member sandwiched in between and being configured to accommodate the linear motion conversion mechanism, and
at least one of a portion of the input member abutting on the load sensor and the load sensor and a portion of the caliper crossing the outer periphery of the rotating body have equal rigidity.
